(19) United States
(12) Patent Application Publication
(10) Pub. No.: US 2019/0149394 A1
(43) Pub. Date: May 16, 2019

(54) HUMIDITY-VIBRATION-DUST-DETECTING SYSTEM

(71) Applicant: AIC INC., Taoyuan City (TW)

(72) Inventors: Jen-Yuan HUANG, Taoyuan City (TW); Wei-Feng HUANG, Taoyuan City (TW)

(21) Appl. No.: 15/815,690

(22) Filed: Nov. 16, 2017

(51) Int. Cl. H04L 29/08; F24F 11/00

(52) U.S. Cl. CPC H04L 29/08099; F24F 2110/20; F24F 11/00

(57) ABSTRACT

A humidity-vibration-dust-detecting system includes a microcontroller, a vibration-detecting module, a humidity-detecting module and a dust-detecting module. The microcontroller includes a storage unit inside the microcontroller. The storage unit stores a vibration-detecting range value, a humidity-detecting range value and a dust-detecting range value. The vibration-detecting module, the humidity-detecting module and the dust-detecting module are electrically connected to the microcontroller respectively. The vibration-detecting module, the humidity-detecting module and the dust-detecting module detect vibration, humidity and dust of internal environment of a machine room or a cabinet respectively, and then send detecting signals to the microcontroller to determine and compare with the vibration-detecting range value, the humidity-detecting range value and the dust-detecting range value. If the detecting signals are within the vibration-detecting range value, the humidity-detecting range value or the dust-detecting range value, the microcontroller sends informing signals to a monitoring host through a local area network.

### BACKGROUND OF THE INVENTION

### Field of the Invention

The present invention relates to a detection system, and especially relates to a detecting system which is arranged in a cabinet or a machine room to detect environmental humidity, vibration and dust of the cabinet or the machine room.

### Description of the Related Art

Currently, the large data storage and operation centers of Internet of Things, artificial intelligence (AI) and so on which require massive data streams are established lively and one after another.

The related art large data processing center only utilizes the central air conditioning system to monitor the whole data center or partly monitor temperature and humidity.

For the server or storage device, the greatest life-influencing factors are dust and the unpredictable natural disaster—earthquake (vibration)—besides temperature and humidity.

### SUMMARY OF THE INVENTION

Therefore, the major object of the present invention is to solve the conventional disadvantages. The present invention designs a humidity-vibration-dust-detecting system which monitors each of server cabinets instantaneously to monitor external influencing factors instantaneously, so that the manager or maintainer can find that the external environment is abnormal immediately. Therefore, environment can be maintained immediately, or the server can be powered off temporarily. After the influencing factors are eliminated, the server will be restarted, so that the working life of the server can be prolonged.

In order to achieve the object mentioned above, the present invention provides a humidity-vibration-dust-detecting system which is arranged in at least a cabinet or at least a machine room. The humidity-vibration-dust-detecting system is connected to a monitoring host through a local area network. The humidity-vibration-dust-detecting system comprises a microcontroller, a vibration-detecting module, a humidity-detecting module and a dust-detecting module. The microcontroller comprises a storage unit. The storage unit stores a vibration-detecting range value, a humidity-detecting range value and a dust-detecting range value for being compared to a vibration-detecting signal, a humidity-detecting signal and a dust-detecting signal to determine whether the vibration-detecting signal, the humidity-detecting signal and the dust-detecting signal are within the vibration-detecting range value, the humidity-detecting range value and the dust-detecting range value. The vibration-detecting module is electrically connected to the microcontroller and is configured to detect an environmental vibration. The humidity-detecting module is electrically connected to the microcontroller and is configured to detect an environmental humidity. The dust-detecting module is electrically connected to the microcontroller and is configured to detect an environmental dust. The vibration-detecting module, the humidity-detecting module and the dust-detecting module are configured to detect the environmental vibration, the environmental humidity and the environmental dust of an internal environment of the machine room or the cabinet respectively to obtain the vibration-detecting signal, the humidity-detecting signal and the dust-detecting signal respectively, and then send the vibration-detecting signal, the humidity-detecting signal and the dust-detecting signal to the microcontroller to determine and compare with the vibration-detecting range value, the humidity-detecting range value and the dust-detecting range value respectively. If the vibration-detecting signal, the humidity-detecting signal or the dust-detecting signal are within the vibration-detecting range value, the humidity-detecting range value or the dust-detecting range value respectively, the microcontroller is configured to send informing signals to the monitoring host through the local area network. Namely, if the vibration-detecting signal is within the vibration-detecting range value, then the microcontroller is configured to send a vibration-informing signal of the informing signals to the monitoring host through the local area network. If the humidity-detecting signal is within the humidity-detecting range value, then the microcontroller is configured to send a humidity-informing signal of the informing signals to the monitoring host through the local area network. If the dust-detecting signal is within the dust-detecting range value, then the microcontroller is configured to send a dust-informing signal of the informing signals to the monitoring host through the local area network.

In an embodiment of the present invention, the storage unit stores the vibration-detecting range value ±2 G, ±4 G, ±6 G, ±8 G. Namely, the vibration-detecting range value stored in the storage unit is ±2, ±4, ±6, or ±8(G).

In an embodiment of the present invention, the storage unit stores the humidity-detecting range value 0-80% RH. Namely, the humidity-detecting range value stored in the storage unit is 0-80% RH.

In an embodiment of the present invention, the storage unit stores the dust-detecting range value 0-250 ug/m3. Namely, the dust-detecting range value stored in the storage unit is 0-250 ug/m3.

In an embodiment of the present invention, the storage unit is a memory.

In an embodiment of the present invention, the vibration-detecting module comprises a vibration-detecting component, a plurality of resistor components and a plurality of capacitor components. The resistor components are electrically connected between pins of the vibration-detecting component and an input power. The capacitor components are electrically connected between the input power and a ground side.

In an embodiment of the present invention, the humidity-detecting module comprises a humidity-detecting component and a plurality of capacitor components. The capacitor components are electrically connected between pins of the humidity-detecting component, an input power and a ground side.

In an embodiment of the present invention, the dust-detecting module comprises a dust-detecting component and an RC (resistor-capacitor) circuit. The RC circuit is electrically connected between pins of the dust-detecting component and an input power.

In an embodiment of the present invention, the monitoring host is connected to a far-end manager through an Internet.

### BRIEF DESCRIPTION OF DRAWING

FIG. 1 shows a block diagram of the humidity-vibration-dust-detecting system of the present invention.

FIG. 2 shows a circuit diagram of the humidity-detecting module of FIG. 1.

FIG. 3 shows a circuit diagram of the vibration-detecting module of FIG. 1.

FIG. 4 shows a circuit diagram of the dust-detecting module of FIG. 1.

FIG. 5 shows a block diagram of the humidity-vibration-dust-detecting system of the present invention arranged in a single cabinet and connected to the monitoring host and the far-end manager.

FIG. 6 shows a block diagram of the humidity-vibration-dust-detecting systems of the present invention arranged in a plurality of cabinets and connected to the monitoring host and the far-end manager.

### DETAILED DESCRIPTION OF THE INVENTION

Please refer to following detailed description and figures for the technical content of the present invention:

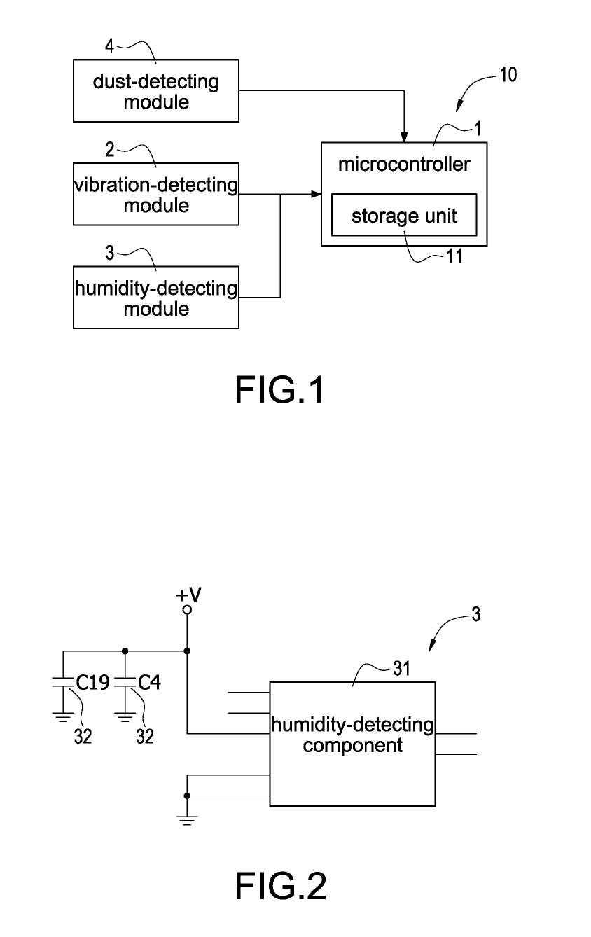

FIG. 1 shows a block diagram of the humidity-vibration-dust-detecting system of the present invention. As shown in FIG. 1, the humidity-vibration-dust-detecting system 10 of the present invention comprises a microcontroller 1, a vibration-detecting module 2, a humidity-detecting module 3 and a dust-detecting module 4. The humidity-vibration-dust-detecting system 10 is arranged in a cabinet (not shown in FIG. 1) or a machine room (not shown in FIG. 1) to detect environmental factors of the cabinet and the machine room to inform a monitoring host (not shown in FIG. 1) of collected data immediately.

The microcontroller 1 (MCU) is in charge of controlling a hardware which performs a system operation. The microcontroller 1 receives input signals, and then outputs control signals according to instructions and responding methods of predetermined programs. The microcontroller 1 comprises a storage unit 11 which is arranged inside the microcontroller 1. The storage unit 11 stores a vibration-detecting range value ±2 G, ±4 G, ±6 G or ±8 G, a humidity-detecting range value 0-80% RH, and a dust-detecting range value 0-250 ug/m3. In FIG. 1, the storage unit 11 is a memory.

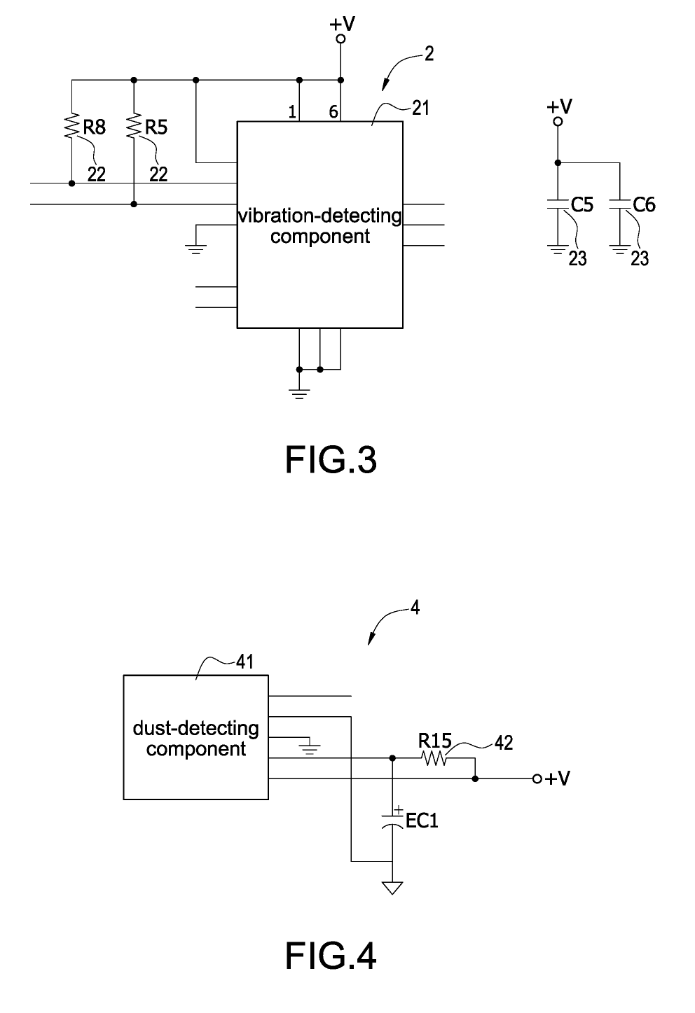

The vibration-detecting module 2 is electrically connected to the microcontroller 1. FIG. 3 shows a circuit diagram of the vibration-detecting module of FIG. 1. Please refer to FIG. 1 as well. The vibration-detecting module 2 comprises a vibration-detecting component 21, a plurality of resistor components 22 and a plurality of capacitor components 23. The resistor components 22 are electrically connected between pins of the vibration-detecting component 21 and an input power. The capacitor components 23 are electrically connected between the input power and a ground side. The vibration-detecting component 21 detects vibration of the cabinet or the machine room to obtain a vibration-detecting signal, and then sends the vibration-detecting signal to the microcontroller 1. The microcontroller 1 determines whether the vibration-detecting signal is within the vibration-detecting range value or not. If the vibration-detecting signal is not within the vibration-detecting range value, the microcontroller 1 does not send out an informing signal. If the vibration-detecting signal is within the vibration-detecting range value, the microcontroller 1 sends the informing signal to a monitoring host (not shown in FIG. 1) through a local area network. The generation of the vibration is that, for example, abrasion formed by a spindle causes that the cabinet is resonant after the spindle of a flabellum of a cooling fan has worked for a certain (long) time, so the normal operation of the server is influenced.

The humidity-detecting module 3 is electrically connected to the microcontroller 1. FIG. 2 shows a circuit diagram of the humidity-detecting module of FIG. 1. Please refer to FIG. 1 as well. The humidity-detecting module 3 comprises a humidity-detecting component 31 and a plurality of capacitor components 32. The capacitor components 32 are electrically connected between pins of the humidity-detecting component 31, the input power and the ground side. The humidity-detecting component 31 detects humidity of the cabinet or the machine room to obtain a humidity-detecting signal, and then sends the humidity-detecting signal to the microcontroller 1. The microcontroller 1 determines whether the humidity-detecting signal is within the humidity-detecting range value or not. If the humidity-detecting signal is not within the humidity-detecting range value, the microcontroller 1 does not send out an informing signal. If the humidity-detecting signal is within the humidity-detecting range value, the microcontroller 1 sends the informing signal to the monitoring host through the local area network.

The dust-detecting module 4 is electrically connected to the microcontroller 1. FIG. 4 shows a circuit diagram of the dust-detecting module of FIG. 1. Please refer to FIG. 1 as well. The dust-detecting module 4 comprises a dust-detecting component 41 and an RC circuit 42. The RC circuit 42 is electrically connected between pins of the dust-detecting component 41 and the input power. The dust-detecting component 41 detects dust (PM2.5) of the cabinet or the machine room to obtain a dust-detecting signal, and then sends the dust-detecting signal to the microcontroller 1. The microcontroller 1 determines whether the dust-detecting signal is within the dust-detecting range value or not. If the dust-detecting signal is not within the dust-detecting range value, the microcontroller 1 does not send out an informing signal. If the dust-detecting signal is within the dust-detecting range value, the microcontroller 1 sends the informing signal to the monitoring host through the local area network.

After the humidity-vibration-dust-detecting system 10 is arranged in the cabinet or the machine room, the humidity-vibration-dust-detecting system 10 detects humidity, vibration and dust of internal environment of the cabinet or the machine room. When the vibration-detecting component 21 of the vibration-detecting module 2 detects the cabinet or the machine room, the vibration-detecting component 21 sends the vibration-detecting signal to the microcontroller 1. The microcontroller 1 determines and compares the vibration-detecting signal with the vibration-detecting range value ±2 G, ±4 G, ±6 G or ±8 G stored in the storage unit 11. If the vibration-detecting signal is not within the vibration-detecting range value, the microcontroller 1 does not send the informing signal to the monitoring host. If the microcontroller 1 determines that the vibration-detecting signal is within ±2 G, ±4 G, ±6 G or ±8 G, the microcontroller 1 sends the informing signal to the monitoring host (not shown in FIG. 1) through the local area network. At this time, the monitoring host informs a far-end manager through the Internet, and then the far-end manager will send someone to the machine room or the cabinet to investigate or process.

When the humidity-detecting component 31 of the humidity-detecting module 3 detects humidity of the cabinet or the machine room, the humidity-detecting component 31 sends the humidity-detecting signal to the microcontroller 1. After the microcontroller 1 receives the humidity-detecting signal, the microcontroller 1 determines and compares the humidity-detecting signal with the humidity-detecting range value 0-80% RH stored in the storage unit 11. If the humidity-detecting signal is not within the humidity-detecting range value, the microcontroller 1 does not send the informing signal to the monitoring host. If the microcontroller 1 determines that the humidity-detecting signal is between 0-80% RH, the microcontroller 1 sends the informing signal to the monitoring host through the local area network. At this time, the monitoring host informs the far-end manager through the Internet, and then the far-end manager will send someone to the machine room or the cabinet to investigate or process.

When the dust-detecting component 41 of the dust-detecting module 4 detects dust of the cabinet or the machine room, the dust-detecting component 41 sends the dust-detecting signal to the microcontroller 1. After the microcontroller 1 receives the dust-detecting signal, the microcontroller 1 determines and compares the dust-detecting signal with the dust-detecting range value 0-250 ug/m3 stored in the storage unit 11. If the dust-detecting signal is not within the dust-detecting range value, the microcontroller 1 does not send the informing signal to the monitoring host. If the microcontroller 1 determines that the dust-detecting signal is between 0-250 ug/m3, the microcontroller 1 sends the informing signal to the monitoring host through the local area network. At this time, the monitoring host informs the far-end manager through the Internet, and then the far-end manager will send someone to the machine room or the cabinet to investigate or process.

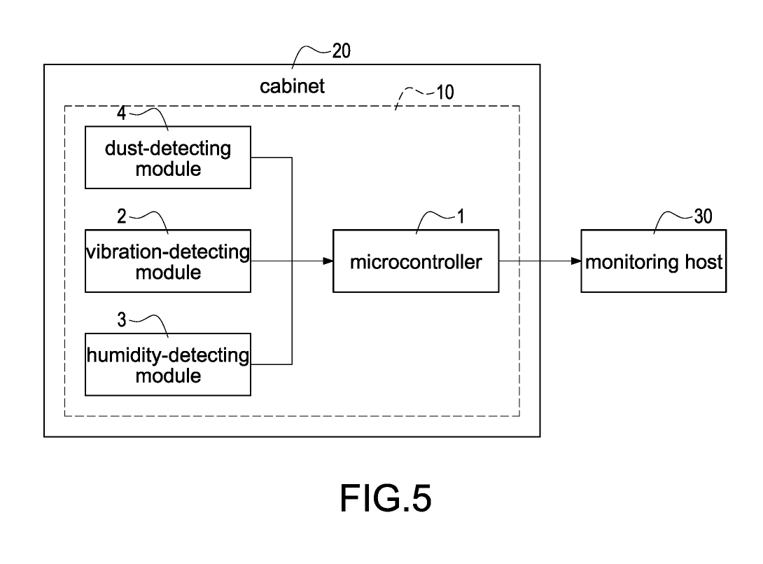

FIG. 5 shows a block diagram of the humidity-vibration-dust-detecting system of the present invention arranged in a single cabinet and connected to the monitoring host and the far-end manager. As shown in FIG. 5, the humidity-vibration-dust-detecting system 10 of the present invention is arranged inside a cabinet 20 and then is connected to a monitoring host 30 through the local area network. The vibration-detecting module 2, the humidity-detecting module 3 and the dust-detecting module 4 detect vibration, humidity and dust of internal environment of the machine room or the cabinet respectively, and then send detecting signals to the microcontroller 1 to determine and compare with the vibration-detecting range value ±2, ±4, ±6, ±8(G), or the humidity-detecting range value 0-80% RH, or the dust-detecting range value 0-250 ug/m3. If the detecting signals are within the vibration, humidity or dust-detecting range values, the microcontroller 1 sends the informing signals to the monitoring host 30 through the local area network, and then the monitoring host 30 sends the informing signals through the Internet to the far-end manager 40 for monitoring.

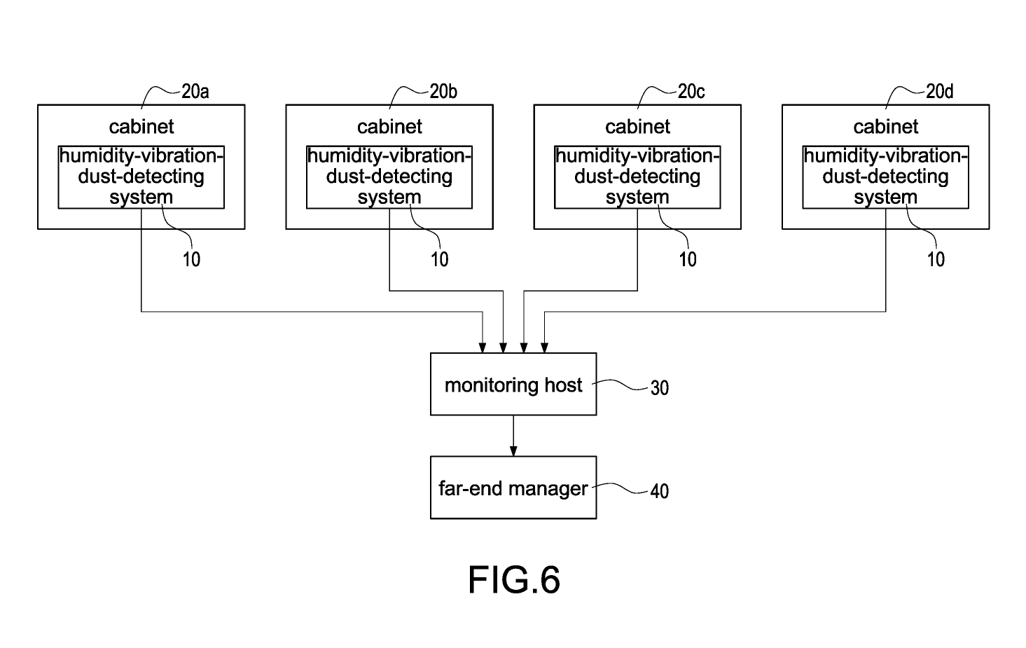

FIG. 6 shows a block diagram of the humidity-vibration-dust-detecting systems of the present invention arranged in a plurality of cabinets and connected to the monitoring host and the far-end manager. As shown in FIG. 6, each of the humidity-vibration-dust-detecting systems 10 of the present invention is arranged inside each of the cabinets 20a, 20b, 20c, 20d, and then is connected to the monitoring host 30 through the local area network. The humidity-vibration-dust-detecting systems 10 detect vibration, humidity and dust of internal environment of the cabinets 20a, 20b, 20c, 20d, and then send detecting signals to the microcontroller 1 to determine and compare with the vibration-detecting range value ±2, ±4, ±6, ±8(G), or the humidity-detecting range value 0-80% RH, or the dust-detecting range value 0-250 ug/m3. If the detecting signals are within the vibration, humidity or dust-detecting range values, the microcontroller 1 sends the informing signals to the monitoring host 30 through the local area network, and then the monitoring host 30 sends the informing signals through the Internet to the far-end manager 40 for monitoring.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A humidity-vibration-dust-detecting system arranged in at least a cabinet or at least a machine room, and connected to a monitoring host through a local area network, the humidity-vibration-dust-detecting system comprising:
a microcontroller comprising a storage unit, the storage unit storing a vibration-detecting range value, a humidity-detecting range value and a dust-detecting range value for compared to a vibration-detecting signal, a humidity-detecting signal and a dust-detecting signal to determine whether the vibration-detecting signal, the humidity-detecting signal and the dust-detecting signal are within the vibration-detecting range value, the humidity-detecting range value and the dust-detecting range value;
a vibration-detecting module electrically connected to the microcontroller and configured to detect an environmental vibration;
a humidity-detecting module electrically connected to the microcontroller and configured to detect an environmental humidity;
a dust-detecting module electrically connected to the microcontroller and configured to detect an environmental dust,
wherein the vibration-detecting module, the humidity-detecting module and the dust-detecting module are configured to detect the environmental vibration, the environmental humidity and the environmental dust of an internal environment of the machine room or the cabinet respectively to obtain the vibration-detecting signal, the humidity-detecting signal and the dust-detecting signal respectively, and then send the vibration-detecting signal, the humidity-detecting signal and the dust-detecting signal to the microcontroller to determine and compare with the vibration-detecting range value, the humidity-detecting range value and the dust-detecting range value respectively; if the vibration-detecting signal, the humidity-detecting signal or the dust-detecting signal are within the vibration-detecting range value, the humidity-detecting range value or the dust-detecting range value respectively, the microcontroller is configured to send informing signals to the monitoring host through the local area network.

2. The humidity-vibration-dust-detecting system in claim 1, wherein the storage unit stores the vibration-detecting range value ±2 g, ±4 g, ±6 g, ±8 g.

3. The humidity-vibration-dust-detecting system in claim 1, wherein the storage unit stores the humidity-detecting range value 0-80% rh.

4. The humidity-vibration-dust-detecting system in claim 1, wherein the storage unit stores the dust-detecting range value 0-250 ug/m3.

5. The humidity-vibration-dust-detecting system in claim 1, wherein the storage unit is a memory.

6. The humidity-vibration-dust-detecting system in claim 1, wherein the vibration-detecting module comprises a vibration-detecting component, a plurality of resistor components and a plurality of capacitor components; the resistor components are electrically connected between pins of the vibration-detecting component and an input power; the capacitor components are electrically connected between the input power and a ground side.

7. The humidity-vibration-dust-detecting system in claim 1, wherein the humidity-detecting module comprises a humidity-detecting component and a plurality of capacitor components; the capacitor components are electrically connected between pins of the humidity-detecting component, an input power and a ground side.

8. The humidity-vibration-dust-detecting system in claim 1, wherein the dust-detecting module comprises a dust-detecting component and an rc circuit; the rc circuit is electrically connected between pins of the dust-detecting component and an input power.

9. The humidity-vibration-dust-detecting system in claim 1, wherein the monitoring host is connected to a far-end manager through an internet.
